(19) United States
(12) Patent Application Publication
(10) Pub. No.: US 2015/0007919 A1
(43) Pub. Date: Jan. 8, 2015

(54) HINGED TYPE LOCKING RING QUICK LOCKING DEVICE

(71) Applicant: WU XI JIDAER WHEEL CO., LTD., Wuxi, JS (CN)

(72) Inventor: Yuan Gao, Wuxi (CN)

(73) Assignee: WU XI JIDAER WHEEL CO., LTD., Wuxi, JS (CN)

(21) Appl. No.: 14/356,606

(22) PCT Filed: Sep. 27, 2013
(86) PCT No.: PCT/CN2013/084485

§ 371 Date: May 7, 2014

(30) Foreign Application Priority Data
Jan. 31, 2013 (CN) 201310036475.1
Jan. 31, 2013 (CN) 201320052946.3

(51) Int. Cl. B60B 25/20; B60B 25/14

(52) U.S. Cl. CPC B60B 25/20; B60B 25/14
USPC 152/409

(57) ABSTRACT

The present invention discloses a hinged type locking ring quick locking device, which is composed of a locking ring and fastening screws. The locking ring consists of an assembly A and an assembly B. The assembly A and the assembly B are connected through a hinge-shaped structure corresponding to one end of the assembly A and one end of the assembly B, and the other ends of the assembly A and the assembly B are of step-shaped structures capable of being closed and corresponding to each other. Threaded holes are arranged at corresponding positions of steps of the step structures, and the assembly A and the assembly B are fixedly connected through the fastening screws. The locking ring can be opened and closed through the hinge-shaped structure and can be installed without too much force.

### CROSS-REFERENCE TO RELATED APPLICATION

This application is the U.S. national phase of International Application No. PCT/CN2013/084485, filed on Sep. 27, 2013, which claims the priority benefit two Chinese Patents which are application No. 201310036475.1, filed on Jan. 31, 2013 and application No. 201320052946.3, filed on Jan. 31, 2013. The entire contents of which is hereby incorporated by reference.

### BACKGROUND OF THE INVENTION

1. Field of Invention

The present invention relates to a fitting of locking ring for automobile tire rims, and particularly to a hinged type locking ring quick locking device for quickly detaching and installing extra large tire rims.

2. Background of Invention

During mining and construction of a large-scale open-pit mine, large construction vehicles have been widely used due to their large load capacity. These large construction vehicles tires also have large tires, generally with a diameter of 3.2-4.2 meters. The locking ring for fastening the tires has a weight of about 60 kilograms, and is made from spring steel. At the time of detaching and installing, the locking ring has to be opened manually by more than one staff. This process is time-consuming and difficult. In addition, in event of any carelessness, the staff may be hurt by large bounce from the locking ring.

### BRIEF SUMMARY OF THE INVENTION

It is an object of the invention to provide a hinged type locking ring quick locking device for quickly detaching and installing tires of large vehicles.

In order to achieve the above object, the present invention adopts the following technical solution.

There is disclosed a hinged type locking ring quick locking device, which is composed of a locking ring and fastening screws, characterized in that: the locking ring consists of an assembly A and an assembly B, the assembly A and the assembly B are connected through a hinge-shaped structure corresponding to one end of the assembly A and one end of the assembly B, and the other ends of the assembly A and the assembly B are of step-shaped structures capable of being closed and corresponding to each other, threaded holes are arranged at corresponding positions of steps of the step structures, and the assembly A and the assembly B are fixedly connected through the fastening screws.

Preferably, in the hinged type locking ring quick locking device, the assembly A and the assembly B are cut from the same metal ring of steel, iron, or alloy.

Preferably, in the hinged type locking ring quick locking device, at the end of the assembly A and the assembly B where they are connected through the hinge-shaped structure, a notch with a certain radian, e.g. a radian of 20°, is arranged at the outer side of the end of the assembly A, and constitutes an opening limiting structure for the locking ring.

Preferably, in the hinged type locking ring quick locking device, four handles are symmetrically arranged on the assembly A and the assembly B at positions close to ends of the step-shaped structures and at respective center of the assembly A and the assembly B.

Preferably, in the hinged type locking ring quick locking device, the four handles which are symmetrically arranged on the assembly A and the assembly B are installed on the assembly A and the assembly B with a slot structure, so that the four handles can be detached flexibly.

Preferably, in the hinged type locking ring quick locking device, two handles are symmetrically arranged on the assembly A and the assembly B at positions close to ends of the step-shaped structures, or at respective center of the assembly A and the assembly B.

The present invention has the following advantages. The locking ring can be opened and closed through the hinge-shaped structure and can be installed without too much force. After the locking ring is closed, the locking ring is locked and fixed through the fastening screws on the step-shaped structures. During detaching, the fastening screws are loosened, and the locking ring can be opened and detached through the hinge-shaped structure. A problem that the existing locking ring is difficult to detach and install is solved, and installing staff is prevented from being hurt by bounce.

### BRIEF DESCRIPTION OF THE DRAWINGS

FIG. 1 is a structural view illustrating a hinged type locking ring quick locking device of the present invention;

FIG. 2 is a structural view illustrating a hinge-shaped structure in the hinged type locking ring quick locking device of the present invention;

FIG. 3 is a structural view illustrating step-shaped structures in the hinged type locking ring quick locking device of the present invention; and

FIG. 4 is a structural view illustrating handles in the hinged type locking ring quick locking device of the present invention.

### DETAILED DESCRIPTION OF THE EMBODIMENTS

The present invention will be further described in detail hereinafter, for purpose of enabling the skilled in the art to implement the present invention by referring to the text in this description.

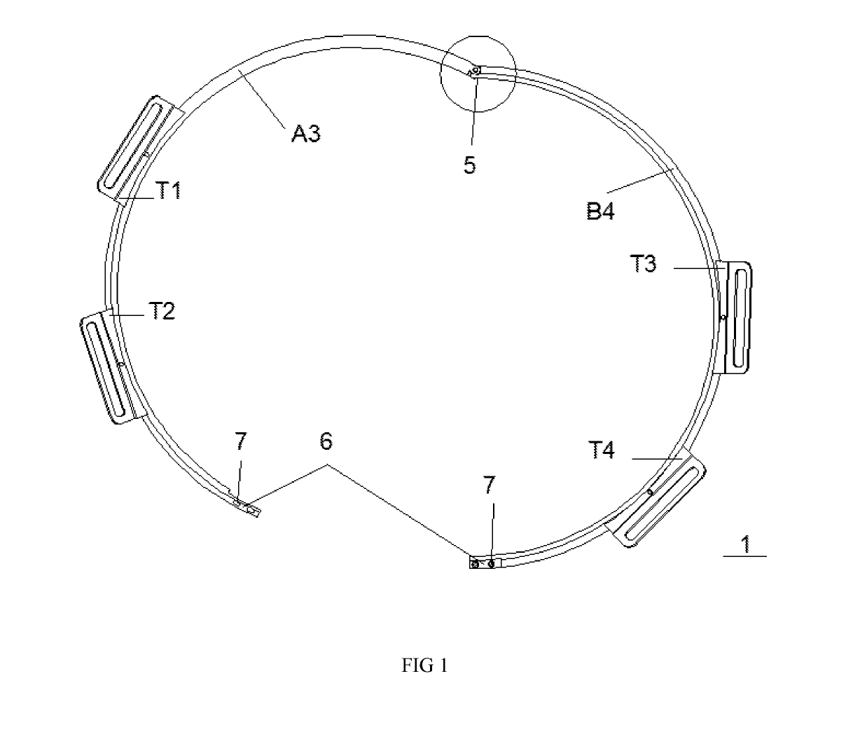

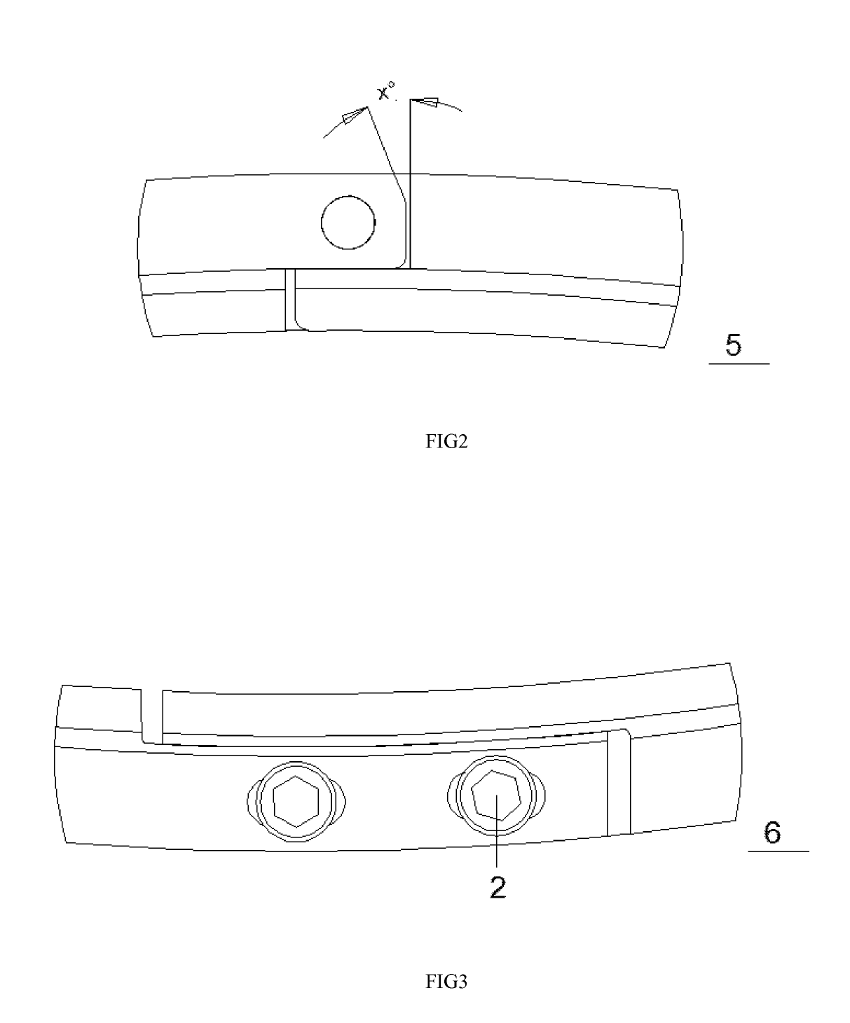

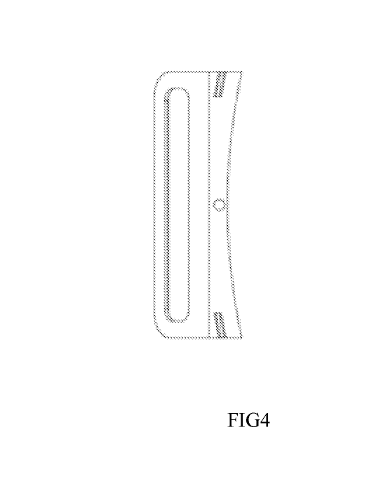

As shown in FIG. 1, FIG. 2, FIG. 3, and FIG. 4, the hinged type locking ring quick locking device is composed of a locking ring 1 and fastening screws 2. The locking ring 1 consists of an assembly A3 and an assembly B4. The assembly A3 and the assembly B4 are connected through a hinge-shaped structure 5 corresponding to one end of the assembly A3 and one end of the assembly B4. The other ends of the assembly A3 and the assembly B4 are of step-shaped structures 6 capable of being closed and corresponding to each other. Threaded holes 7 are arranged at corresponding positions of steps of the step structures, and the assembly A3 and the assembly B4 are fixedly connected through the fastening screws 2.

Preferably, the assembly A3 and the assembly B4 are cut from the same metal ring of steel, iron, or alloy. For example, they are cut from a spring steel ring at its middle position.

Preferably, at the end of the assembly A3 and the assembly B4 where they are connected through the hinge-shaped structure, a notch with a certain radian X, e.g. a radian X of 20°, is arranged at the outer side of the end of the assembly A3, and constitutes an opening limiting structure for the locking ring. In this way, when the assembly A3 and the assembly B4 are opened to a certain distance, the end of the assembly A3 will rest against a middle position in the cross section of the end of the assembly B4. Thus, the assembly A3 and the assembly B4 can only be opened to a maximum distance, which prevents the assembly A3 and the assembly B4 from opening excessively.

Preferably, four handles T1, T2, T3, and T4 are symmetrically arranged on the assembly A3 and the assembly B4 at positions close to ends of the step-shaped structures 6 and at respective center of the assembly A3 and the assembly B4. These four handles can be installed on the assembly A3 and the assembly B4 with a slot structure, so that the four handles can be detached flexibly. These four handles can also be reduced to two handles, which are symmetrically arranged on the assembly A3 and the assembly B4 at positions close to ends of the step-shaped structures, or at respective center of the assembly A3 and the assembly B4.

During installing, the locking ring 1 can be opened through the hinge-shaped structure 5 without too much force, making it easy to install. When the locking ring 1 is closed, it is locked and fixed through the fastening screws 2 on the step-shaped structures 6. During detaching, the fastening screws 2 are loosened, and the locking ring 1 can be opened and detached through the hinge-shaped structure 5. A problem that the existing locking ring is difficult to detach and install is solved, and installing staff is prevented from being hurt by bounce.

The device of the invention is particularly suitable for the existing 51″-63″ rims and has good popularization benefit.

Although the present invention has been disclosed with the above implementations, the present invention is not limited to the applications set forth in the description and implementations, but can be applied to various fields to which the present invention is applicable. Modifications to the implementations are apparent to the skilled in the art. Therefore, without departing from the general concept as defined by claims and equivalents thereto, the present invention is not limited to specific details and the diagrams illustrated in the present disclosure.

1. A hinged type locking ring quick locking device, which is composed of a locking ring and fastening screws, characterized in that, the locking ring consists of an assembly A and an assembly B, the assembly A and the assembly B are connected through a hinge-shaped structure corresponding to one end of the assembly A and one end of the assembly B, the other ends of the assembly A and the assembly B are of step-shaped structures capable of being closed and corresponding to each other, threaded holes are arranged at corresponding positions of steps of the step structures, and the assembly A and the assembly B are fixedly connected through the fastening screws.

2. The hinged type locking ring quick locking device of claim 1, characterized in that, the assembly A and the assembly B are cut from the same metal ring of steel, iron, or alloy.

3. The hinged type locking ring quick locking device of claim 1, characterized in that, at the end of the assembly A and the assembly B where they are connected through the hinge-shaped structure, a notch with a certain radian, e.g. a radian of 20°, is arranged at the outer side of the end of the assembly A, and constitutes an opening limiting structure for the locking ring.

4. The hinged type locking ring quick locking device of claim 1, characterized in that, four handles are symmetrically arranged on the assembly A and the assembly B at positions close to ends of the step-shaped structures and at respective center of the assembly A and the assembly B.

5. The hinged type locking ring quick locking device of claim 4, characterized in that, the four handles which are symmetrically arranged on the assembly A and the assembly B are installed on the assembly A and the assembly B with a slot structure, so that the four handles can be detached flexibly.

6. The hinged type locking ring quick locking device of claim 4, characterized in that, two handles are symmetrically arranged on the assembly A and the assembly B at positions close to ends of the step-shaped structures, or at respective center of the assembly A and the assembly B.

7. The hinged type locking ring quick locking device of claim 5, characterized in that, two handles are symmetrically arranged on the assembly A and the assembly B at positions close to ends of the step-shaped structures, or at respective center of the assembly A and the assembly B.
